(19) United States
(12) Patent Application Publication
(10) Pub. No.: US 2024/0165556 A1
(43) Pub. Date: May 23, 2024

(54) ENHANCING CO2 MINERALIZATION DURING CO2 SEQUESTRATION PROCESS IN BASALTIC FORMATIONS

(71) Applicant: SAUDI ARABIAN OIL COMPANY, Dhahran (SA)

(72) Inventors: Zuhair AlYousef, Saihat (SA); Ali Abdullah Al-Taq, Qatif (SA); Muhammad M. Almajid, Qatif (SA)

(73) Assignee: SAUDI ARABIAN OIL COMPANY, Dhahran (SA)

(21) Appl. No.: 18/058,374

(22) Filed: Nov. 23, 2022

(51) Int. Cl. B01D 53/62; B01D 53/75; B01D 53/78; B01D 53/79

(52) U.S. Cl. CPC B01D 53/62; B01D 53/75; B01D 53/78; B01D 53/79; B01D 2251/206; B01D 2251/304; B01D 2257/504

(57) ABSTRACT

A method for treating a basaltic formation includes providing a CO₂-rich fluid in the basaltic formation, generating one or more metal ions from a metal ion source in the basaltic formation with the CO₂-rich fluid, providing heat from a thermogenic reaction between a first salt solution and a second salt solution in the basaltic formation, and enhancing a reaction between the one or more metal ions and the CO₂-rich fluid with the heat, thereby treating the basaltic formation. A system for treating a basaltic formation including a metal ion source includes a CO₂-rich fluid that includes a source of carbon dioxide dissolved in a first aqueous fluid, a first salt solution that includes a first thermogenic agent dissolved in a second aqueous fluid, and a second salt solution that includes a second thermogenic agent dissolved in a third aqueous fluid.

### BACKGROUND

Carbon dioxide (CO₂) is a naturally occurring compound that is present in Earth's atmosphere. The CO₂ in the atmosphere may be derived from natural sources, such as respiration, or from human activities, such as the combustion of fossil fuels. The environmental effects of CO₂ in the atmosphere are of particular concern because CO₂ is a “greenhouse gas”. A greenhouse gas can absorb light and radiate heat instead of reflecting it, elevating the temperature of the gas. In efforts to slow the rate of global warming, carbon capture and storage (CCS) has emerged as a possible solution for reducing CO₂ in the atmosphere. In a typical CCS process, atmospheric CO₂ is captured, compressed, and transported with the eventual goal of long-term storage in underground geological formations.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of treating a basaltic formation. The method includes providing a CO₂-rich fluid in the basaltic formation, generating one or more metal ions from a metal ion source in the basaltic formation with the CO₂-rich fluid, providing heat from a thermogenic reaction between a first salt solution and a second salt solution in the basaltic formation, and enhancing a reaction between the one or more metal ions and the CO₂-rich fluid with the heat, thereby treating the basaltic formation.

In another aspect, embodiments disclosed herein relate to a system for treating a basaltic formation including a metal ion source. The system includes a CO₂-rich fluid that includes a source of carbon dioxide dissolved in a first aqueous fluid, a first salt solution that includes a first thermogenic agent dissolved in a second aqueous fluid, and a second salt solution that includes a second thermogenic agent dissolved in a third aqueous fluid.

Other aspects and advantages of the claimed subject matter will be apparent from the following description and the appended claims.

### BRIEF DESCRIPTION OF DRAWINGS

FIG. 1 is a block flow diagram of a method of treating a basaltic formation in accordance with one or more embodiments.

### DETAILED DESCRIPTION

Carbon dioxide (CO₂) can be sequestered in geologic formations by four main mechanisms that include structural stratigraphic trapping, capillary residual trapping, solubility trapping, and mineral trapping. The efficiency of these CO₂ sequestration methods into formations depends on a storage capacity of the formation, reservoir stability and potential risk of leakage. For example, CO₂ may be dissolved in a first aqueous fluid and injected in a basaltic formation in which mineralization may occur.

However, the rate of mineralization of CO₂ in a basaltic formation can be a prolonged process, in which the mineralization of CO₂ can take years to mineralize. For example, a solution of CO₂ may be injected into a basaltic formation such that CO₂ is sequestered as mineralized carbonates in about 2 years at about 30° C. In such instances, the injected CO₂ in may be unintentionally released from the fluid via gasification, during which the CO₂ gas often migrates away from the desired sequestration location and can be released into the atmosphere. Notably, basaltic formations of higher temperatures, such as about 250° C., that have been treated with an injected CO₂ solution may be mineralized within several months.

In one aspect, embodiments of the present disclosure relate to systems and methods for treating a basaltic formation downhole. The systems and methods may include a thermogenic reaction to enhance a rate of mineralization of CO₂ in basaltic formations, increase a CO₂ sequestration efficiency, or both. The rate of mineralization of CO₂ in basaltic formations according to a treatment method of one or more embodiments is enhanced compared to a rate of mineralization without a treatment method of one or more embodiments. In one or more embodiments, one or more formation parameters, such as minerals present in the formation, a CO₂ phase, formation pressure and formation temperature, or combinations thereof, further enhances the rate of CO₂ mineralization along with the thermogenic reaction.

A system of one or more embodiments may include a system for treating a basaltic formation including a metal ion source. In one or more embodiments, the downhole basaltic formation treatment system includes a metal ion source. The metal ion source composition may include one or more metal-containing minerals, such as calcium containing minerals, magnesium containing minerals, iron containing minerals, or combinations thereof. Non-limiting examples of metal-containing minerals include fosterite, plagioclase, or combinations thereof. The metal ion source composition may include a downhole formation rock of the basaltic formation. The formation rock may include ultra-mafic rock, mafic rock, basaltic rock, or combinations thereof.

The system for treating a basaltic formation including a metal ion source may include a CO₂-rich fluid, a first salt solution, and a second salt solution. In one or more embodiments, the CO₂-rich fluid includes a source of CO₂ dissolved in a first aqueous fluid. The source of CO₂ may be CO₂ that has been captured and compressed.

In one or more embodiments, the first aqueous fluid is a water-based fluid. The water-based fluid may be distilled water, brine, deionized water, tap water, fresh water from surface or subsurface sources, formation water produced from the structural low, formation water produced from a different geologic formation, production water, frac or flowback water, natural and synthetic brines, residual brine from desalination processing, a regional water source, such as fresh water, brackish water, natural and synthetic sea water, potable water, non-potable water, ground water, seawater, other waters, and combinations thereof, that are suitable for use in a wellbore environment. In one or more embodiments, the water used may naturally contain contaminants, such as salts, ions, minerals, organics, and combinations thereof, as long as the contaminants do not interfere with the precipitation of CO₂ from the CO₂-rich water, a thermogenic reaction, or both. In one or more embodiments, the water-based fluid includes additives such as viscosifiers, polymers, surfactants, and combinations thereof.

The water-based fluids of one or more embodiments may include other additives provided the additives do not interfere with the precipitation of CO₂ from the CO₂-rich water, a thermogenic reaction, or both. Such additives may include, for instance, one or more wetting agents, corrosion inhibitors, biocides, surfactants, dispersants, interfacial tension reducers, mutual solvents, and thinning agents. The identities and use of the aforementioned additives are not particularly limited. One of ordinary skill in the art will, with the benefit of this disclosure, appreciate that the inclusion of a particular additive will depend upon the stage of reservoir operations, desired application, and properties of a given wellbore fluid.

In one or more embodiments, the system may include CO₂ dissolved in a sufficient amount of a first aqueous fluid such that the gas is completely dissolved and maintains the form of a CO₂-rich fluid at the depth of the release into the target basaltic formation. The CO₂ may be dissolved in a sufficient amount to maximize an efficiency of the mineralization process. In one or more embodiments, the amount of CO₂ dissolved in the first aqueous fluid may be dependent upon a temperature and/or pressure of the basaltic formation.

In one or more embodiments, the solubility of CO₂ is salinity dependent. As salinity of the first aqueous fluid decreases, the solubility of CO₂ in the first aqueous fluid increases. Generally, CO₂ solubility in brine decreases as salinity increases due to the so-called “salting out” effect. Comparisons between different salinities indicate that CO₂ solubility decreases nearly 49% when the salinity increases from about 0 M (Molar) to about 4 M aqueous NaCl solutions. In one or more embodiments, more CO₂ is dissolved in a water-based fluid as described above with a lower salinity than a water-based fluid with high salinity. A lower amount of a water-based fluid may be needed when water of low salinity is used for the same amount of CO₂ available under the same temperature and pressure conditions when compared to a high salinity water. In addition, when more CO₂ is dissolved in water, the pH of the water decreases.

In one or more embodiments, the CO₂ sequestration in basaltic formations includes capturing CO₂ via solvation in an aqueous fluid. The solubilization of CO₂ in the aqueous fluid may be represented by Equation (1), below.

CO₂(g)+H₂O(aq) [symbol] H₂CO₃(aq) (1)

As provided above, CO₂ gas may react with water (H₂O) to dissolve and provide aqueous carbonic acid (H₂CO₃). Once dissolved in water in the form of carbonic acid, CO₂ may no longer be buoyant, providing a dense and acidic CO₂-rich fluid. The acidity of the CO₂-rich fluid may be represented by the reversible dissociation of carbonic acid in Equation (3), below.

H₂CO₃(aq) [symbol] HCO₃⁻(aq)+H⁺(aq) (2)

As such, free hydrogen of dissolved CO₂ may provide an acidic CO₂-rich fluid with a pH of about 7.0 or less, about 6.0 or less, about 4.0 or less, about 3.0 or less, or about 2.0 or less. As a result, it is expected that when more CO₂ is dissolved in a lower salinity water based fluid to produce a CO₂-rich fluid with a pH of about 7.0 or less, reactivity with one or more metal ion sources of a formation, reactivity of a first salt solution and a second salt solution, or both may be expedited. In one or more embodiments, the basaltic treatment system includes an acidic CO₂-rich fluid in contact with a first salt solution, the second salt solution, a metal ion of the basaltic formation, or combinations thereof downhole.

The first salt solution may include a first thermogenic agent dissolved in a second aqueous fluid. The first thermogenic agent may include an ammonium-based compound. The ammonium-based compound may be an ammonium salt. For example, in some embodiments the ammonium containing compound may be ammonium chloride (NH₄Cl), ammonium bromide (NH₄Br), ammonium nitrate (NH₄NO₃), ammonium nitrite (NH₄NO₂), ammonium sulfate ((NH₄)₂SO₄), ammonium carbonate ((NH₄)₂CO₃), or combinations of these. In one or more embodiments, the second aqueous fluid may be a water-based solution as described above.

In one or more embodiments, the first salt solution may include an acid. A variety of acids may be used. In one or more embodiments, the acid is selected from the group consisting of hydrochloric acid (HCl), hydrofluoric acid (HF), acetic acid (CH₃COOH), formic acid (HCOOH), and combinations thereof.

The second salt solution may include a second thermogenic agent dissolved in a third aqueous fluid. In one or more embodiments, the third aqueous fluid is a water-based fluid as described above. In one or more embodiments, the second thermogenic agent is a nitrite-based compound. The nitrite-based compound may be a nitrite salt. For example, in some embodiments the nitrite-based compound may be selected from the group consisting of sodium nitrite (NaNO₂), potassium nitrite (KNO₂), and combinations thereof. In some embodiments, the second salt solution composition is substantially free of acid. As used in the present disclosure, “substantially free” means that the second solution includes less than 5% by volume, less than 4% by volume, less than 3% by volume, less than 2% by volume, less than 1% by volume, or less than 0.1% by volume of an acid. Acid present in the second salt solution may result in undesirable nitric oxide and side product generation when the acid is mixed with the nitrite-based compound.

In one or more embodiments, the ammonium-based compound and the nitrite-based compound may independently range concentration of the first salt solution and the second salt solution, respectively. The independent concentrations may be in a range with a lower limit of one of about 1 M (Molar), about 1.5 M, about 2.0 M, about 2.5 M, about 3.0 M, about 3.5 M, about 4.0 M, and about 5.0 M with an upper limit of one of about 2.0 M, about 3.0 M, about 4.0 M, about 5.0 M, and about 6 M, where a value of the lower limit may be paired with a mathematically compatible value of the upper limit. In one or more embodiments, the concentration of the nitrite-based compound of the second salt solution composition is approximately two times the concentration of the ammonium-based compound of the first salt solution.

In one or more embodiments, the molar ratio of the nitrite-based compound of the second salt solution composition to the ammonium-based compound introduced to the subterranean formation may be from 1:1 to 3:1. For example, in some embodiments the molar ratio of NaNO₂ to NH₄Cl introduced to the subterranean formation may be from 1:1 to 3:1; from 1.5:1 to 3:1; from 2:1 to 3:1; from 2.5:1 to 3:1; from 1:1 to 2.5:1; from 1:1 to 2:1; from 1:1 to 1.5:1; from 1.5:1 to 2.5:1; from 1.5:1 to 2:1; or from 2:1 to 2.5:1.

In one or more embodiments, a greater molar ratio of NaNO₂ relative to NH₄Cl allows for an increased thermogenic reaction rate. A NaNO₂ to NH₄Cl molar ratio of at least 2:1 may allow for the first salt solution composition and the second salt solution composition may include the reactants to be provided in a volume ratio of 1:1, which may provide practical industrial benefits.

In one or more embodiments, the concentration and/or molar ratio of the nitrite-based compound of the second salt solution composition to the ammonium-based compound depends on a desired amount of heat to generate from a reaction between the ammonium-based compound and the nitrite-based compound. For example, a desired amount of heat released may relate to an increase in temperature from about 70° F. to about 600° F. In one or more embodiments, the increase in temperature is in a range with a lower limit of one of about 70° F., about 80° F., about 90° F., about 100° F., about 150° F., about 200° F., about 250° F., about 300° F., about 350° F., about 400° F., and about 450° F. and an upper limit of one of about 150° F., about 200° F., about 250° F., about 300° F., about 350° F., 400° F., about 450° F., about 500° F., and about 600° F., where a value of the lower limit may be paired with a value of a mathematically compatible upper limit.

The concentration of the nitrite-based compound in the second salt solution and ammonium-based compound in the first salt solution may be selected based on the reaction kinetics of the system, the solubility of the compounds based on a formation temperature, a formation pressure, a target amount of CO₂ to be sequestered from the CO₂-rich fluid, or combinations thereof. For example, when the molar ratio of NaNO₂ to NH₄Cl is at least 1:1 the reaction may occur spontaneously at a more acidic pH, such as equal to or less than about 4.0, or at a temperature equal to or greater than about 60° C. In one or more embodiments, the concentration of the nitrite-based compound in the second salt solution, the ammonium-based compound in the first salt solution, the amount of CO₂ to be mineralized, or combinations thereof are determined via simulation of formation parameters.

In one or more embodiments, the basaltic formation treatment system includes an injection system, one or more fluid transport lines, or combinations thereof. The system may be configured to separate injecting the first salt solution and the second salt solution, where the second salt solution is capable of reaction with the first salt solution upon contact, under injection conditions, and under conditions in the basaltic formation. For example, the injection system may include a first salt solution transport line configured to inject the first salt solution composition. The second salt solution transport line may be inserted into the injection well of a basaltic formation. The injection system may include a second salt solution transport line configured to inject the second salt solution composition. The second salt solution transport line may be inserted into the injection well of a basaltic formation. The injection system may include a CO₂-rich fluid transport line configured to inject the CO₂-rich fluid composition. In one or more embodiments, the first salt solution transport line and the CO₂-rich fluid transport line are the same.

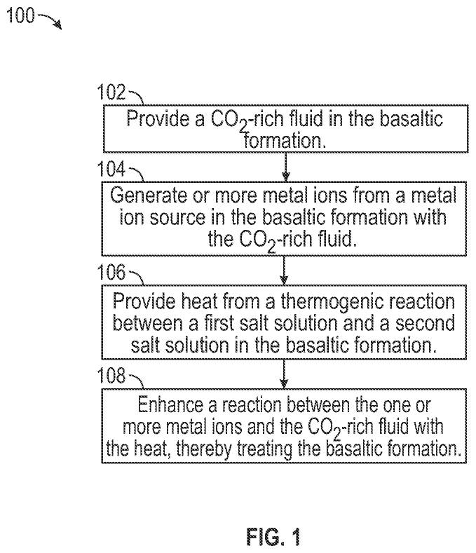

In another aspect, one or more embodiments relate to a method of treating a basaltic formation. FIG. 1 provides a method 100 for treating a basaltic formation with a CO₂-rich fluid in accordance with one or more embodiments. The method includes block 102 in which the CO₂-rich fluid is provided in the basaltic formation. The CO₂-rich fluid may be injected into the basaltic formation via a CO₂-rich fluid transport line as described above. In block 104 of method 100, one or more metal ions may be generated from a metal ion source in the basaltic formation with the CO₂-rich fluid. Heat from a thermogenic reaction between a first salt solution and a second salt solution in the basaltic formation may be provided as shown in block 106.

In one or more embodiments, the method includes injecting a first salt solution and a second salt solution in the basaltic formation. The first salt solution and the second salt solution may be injected separately into the basaltic formation. In one or more embodiments, the first salt solution and the second salt solution may be injected separately via a first salt solution transport line and a second salt solution transport line as described above.

In one or more embodiments, the first salt solution, the second salt solution, and the CO₂-rich fluid are introduced into the subterranean formation sequentially. In one or more embodiments, the CO₂-rich fluid is injected into the formation prior to the injection of the first salt solution and the second salt solution. The first salt solution, the second salt solution, or both may be injected as a formation pre-flush treatment. In one or more embodiments, the CO₂-rich fluid is injected after the injection of the first salt solution and the second salt solution. In one or more embodiments, the CO₂-rich fluid is injected after a reaction, such as a thermogenic reaction, between first salt solution and the second salt solution is provided. In one or more embodiments, the first salt solution, the second salt solution, and the CO₂-rich fluid are simultaneously introduced to the basaltic formation via separate fluid transport lines as described above such that the solutions are mixed in the formation.

The second salt solution may be reactive with the first salt solution under the conditions in the basaltic formation after the injecting. In one or more embodiments, the thermogenic reaction is a reaction that occurs between a first salt solution and a second salt solution. A non-limiting example of the thermogenic reaction is shown in Equation (3) using NH₄Cl as the ammonium-based compound and NaNO₂ as the nitrite-based compound, which react to generate heat and nitrogen gas. However, it should be understood by a person of ordinary skill in the art that compounds of similar class of reactants may generally react in a similar way as the example reaction schemes shown in Equation (3).

NH₄Cl+NaNO₂+2H₂O→N₂(g)+NaCl+H₂O+ Heat Equation (3)

The chemical equilibrium and reaction dynamics are affected by at least temperature, pressure, pH, and molar ratios of reactants. In the reaction as provided in Equation (3), the enthalpy of reaction (ΔH_{Rx}) is about −79.95 kcal mol⁻¹ (kilocalories per mole) with an irreversible equilibrium constant (K_{eq})=3.9×1071 Pa×mol m⁻³ (pascal-mole per cubic meter) at 25° C. In one or more embodiments, the heat generated from Equation (3) increases a rate of mineralization of carbon dioxide to metal carbonates.

The first salt solution and second salt solution may mix to form a thermogenic mixture in the formation. The thermogenic mixture may be maintained downhole in the basaltic formation, allowing the ammonium-based compound and the nitrite-based compound to react such that heat and nitrogen gas are generated from the thermogenic reaction under the conditions in the basaltic formation. The conditions may be selected from the group consisting of temperature, pH, and combinations thereof. In one or more embodiments, the conditions in the basaltic formation include a temperature of at least 60° C. or above such that a thermogenic reaction of the first salt solution and the second salt solution is triggered, thereby providing the thermogenic reaction. A temperature of the formation may be increased to provide the thermogenic reaction.

The conditions may include a pH less than or equal to about 4.0 in a formation in which the temperature is not equal to or greater than 60° C. However, if the pH is too acidic, the concentration of the ammonium containing compound may be unnecessarily diluted and the subsequent resulting nitrogen gas and heat generation may be unnecessarily decreased. Therefore, the conditions may have a sufficiently acidic pH for providing the thermogenic reaction and generation of heat and nitrogen while also preventing the dilution of the ammonium-based compound of the first salt solution.

As described above, the first salt solution may include an acid such that a pH of the thermogenic mixture is about 4.0 or below. The pH of about 4.0 or less of the thermogenic mixture may trigger the thermogenic reaction such that the pH of about 4.0 or less provides the thermogenic reaction. In one or more embodiments, the threshold pH of the treatment mixture is in a range with a lower limit from a pH of about 1.0, a pH of about 1.5, a pH of about 2.0, a pH of about 2.5, a pH of about 3.0, a pH of about 3.5, and a pH of about 4.0 to an upper limit of a pH of about 3.5, a pH of about 4.0, a pH of about 4.5, a pH of about 5.0, a pH of about 5.5, a pH of about 6.0, a pH of about 6.5, or a pH of about 7.0, where a value of the lower limit may be combined with a value of a mathematically compatible upper limit.

In one or more embodiments, the first salt solution and the second salt solution may mix to form an unreacted thermogenic mixture in the formation. An unreacted thermogenic mixture may form with a formation temperature below about 60° C. or less. In one or more embodiments, the thermogenic mixture with a pH above about 4.5 or more provided in a basaltic formation of about 60° C. or below is an unreacted thermogenic mixture. The conditions in the basaltic formation may include a pH of an unreacted thermogenic mixture of above about 4.0 before providing the CO₂-rich fluid, wherein the CO₂-rich fluid has a pH of about 4.0 or less, whereby the CO₂-rich fluid triggers the thermogenic reaction.

In one or more embodiments, a mixture of the first salt solution, the second salt solution, the CO₂-rich fluid, or combinations thereof provides a thermogenic reaction. In one or more embodiments, the unreacted thermogenic mixture reacts to provide a thermogenic reaction upon contact and/or mixing with the CO₂-rich fluid. The CO₂-rich fluid may be an acidic CO₂-rich fluid as described above such that the acidic CO₂-rich fluid triggers the unreacted thermogenic mixture to provide the thermogenic reaction. As the acid may be in the form of carbonic acid from the CO₂-rich fluid, the thermogenic reaction may occur immediately upon mixing of the unreacted thermogenic mixture and/or the CO₂-rich fluid when the pH of the mixed fluid is less than or equal to about 4.0. Consequently, the introduction of the first salt solution and the second salt solution into a formation, followed by the CO₂-rich fluid may trigger the thermogenic reaction between the first salt solution and the second salt solution, thereby providing the thermogenic reaction to generate heat and nitrogen gas.

In one or more embodiments, the amount of heat generated from the thermogenic reaction is controlled to mitigate or prevent the evaporation of CO₂ from the CO₂-rich fluid. Controlling the thermogenic reaction may include adapting the concentration of the first thermogenic agent, the second thermogenic agent, or both in the salt solutions to offset one or more parameters, such as formation pressure, temperature, salinity, or combinations thereof.

In one or more embodiments, an acid in the form of carbonic acid present in the CO₂-rich fluid is sufficient to trigger a reaction of Equation (3) as described above. The CO₂-rich fluid may be injected after the injection of the first and second salt solutions forming the unreacted thermogenic mixture.

A parameter that further enhances the reactivity of CO₂-rich fluid with a metal ion source of a basaltic formation is the acidity of the CO₂-rich fluid. In one or more embodiments, the CO₂-rich fluid reacts with a metal ion source to generate one or more metal cations. In one or more embodiments, the metal-containing minerals may react with free hydrogens of an acidic solution, such an acidic CO₂-rich fluid to generate one or more metal cations.

Mg₂SiO₄(s)+4H⁺(aq)→2Mg²⁺(aq)+H₂O+SiO₂(aq) Equation (4)

CaAl₂Si₂O₈(s)+8H⁺(aq)→Ca²⁺2Al³⁺(aq)+4H₂O+2SiO₂(aq) Equation (5)

Equation (4) describes the consumption of free hydrogen ions by fosterite (Mg₂SiO₄) to release magnesium cations. Equation (5) describes the consumption of free hydrogen ions by plagioclase (CaAl₂Si₂O₈) to release calcium and aluminium cations. The one or more metal cations generated may be solubilized by one or more water-based fluids present in the formation to form a mineralization mixture. The one or more water-based fluids may be a first aqueous fluid, a second aqueous fluid, or combinations thereof to form a mineralization mixture. In one or more embodiments, the generated one or more metal cations of the mineralization mixture may react with dissolved CO₂, such as the dissolved CO₂ of a CO₂-rich fluid.

In one or more embodiments, providing the reaction between the one or more metal ions and the CO₂-rich fluid includes increasing a temperature of a mineralization mixture via heat released from the thermogenic reaction. The one or more metal cations in an mineralization mixture may react with dissolved CO₂ in the form of carbonic acid to form one or more metal carbonates as described in Equation (6).

(Ca,Mg,Fe)²⁺(aq)+H₂CO₃(aq)→(Ca,Mg,Fe)CO₃(s)+2H⁺(aq) Equation (6)

The one or more metal carbonates may be one or more solid metal carbonates. The one or more metal carbonates may include calcium carbonate, magnesium carbonate, iron carbonate, aluminum carbonate, or combinations thereof. The degree to which the generated one or more cations form stable carbonate minerals may depend on the identity of the metal ion, a pH of a mineralization mixture, and a temperature of a mineralization mixture.

As mentioned above, a temperature of the mineralization mixture may increase via absorption of heat provided from the thermogenic reaction. This increased temperature may enhance the reaction between the one or more metal ions and the CO₂-rich fluid of Equation (6) with the heat, which includes increasing a temperature of a mineralization mixture that includes the one or more metal ions and the CO₂-rich fluid via the heat to enhance a production rate of one or more metal carbonates. The enhanced production rate of one or more metal carbonate formation may include increasing a rate of reaction between the CO₂-rich fluid and the one or more metal ions. Therefore, the treating the basaltic formation includes enhancing a mineralization rate of CO₂ in the basaltic formation.

In one or more embodiments, the reaction between the one or more metal ions and the CO₂-rich fluid includes precipitating CO₂ from the CO₂-rich fluid in the form of one or more solid metal carbonates, thereby sequestering the precipitated CO₂ in the basaltic formation. The increased rate of one or more solid metal carbonate formation may be an enhanced rate of precipitation of CO₂ from a CO₂-rich fluid of the mineralization mixture.

In one or more embodiments, the reaction of Equation (6) occurs if the hydrogen ions produced in Equation (6) are consumed by an additional reaction. In one or more embodiments, the additional reaction may be the thermogenic reaction, a reaction providing the release of one or more metal ions as described in Equation (4), Equation (5), or combinations thereof, thereby perpetuating the release of metal cations to precipitate CO₂.

Embodiments of the present disclosure may provide at least one of the following advantages. In one or more embodiments, a rate of mineralization of CO₂ in a basaltic formation, a CO₂ sequestration efficiency in a basaltic formation, or both are increased. In a basaltic formation, the rate of mineralization, CO₂ sequestration efficiency, or both may be increased as a result of a treatment of the formation with a thermogenic reaction and a CO₂-rich fluid. The amount of CO₂ sequestered in a basaltic formation according to one or more embodiments may be enhanced compared to a sequestration efficiency of a formation without an elevated temperature or treatment to provide an elevated temperature. The elevated temperature may be about 200° C. or above. For example, methods of one or more embodiments may provide at least about 80% targeted CO₂ sequestration in about 6 months or less, about 5 months or less, about 4 months or less, or about 3 months or less compared to a formation that has not been treated.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range. While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A method of treating a basaltic formation, the method comprising:
providing a CO₂-rich fluid in the basaltic formation;
generating one or more metal ions from a metal ion source in the basaltic formation with the CO₂-rich fluid;
providing heat from a thermogenic reaction between a first salt solution and a second salt solution in the basaltic formation; and
enhancing a reaction between the one or more metal ions and the CO₂-rich fluid with the heat, thereby treating the basaltic formation.

2. The method of claim 1, further comprising injecting the first and second salt solution together into the basaltic formation, wherein the second salt solution is reactive with the first salt solution under the conditions in the basaltic formation after the injecting.

3. The method of claim 2, wherein the conditions are selected from the group consisting of temperature, pH, and combinations thereof.

4. The method of claim 3, wherein the conditions comprise a temperature of about 60° C. or above.

5. The method of claim 3, wherein the conditions comprise a pH of about 4.0 or below.

6. The method of claim 3, wherein the conditions comprise a pH of above about 4.0 before providing the CO₂-rich fluid, wherein the CO₂-rich fluid has a pH of about 4.0 or less, whereby the CO₂-rich fluid triggers the thermogenic reaction.

7. The method of claim 1, further comprising separately injecting the first salt solution and the second salt solution, wherein the second salt solution is capable of reaction with the first salt solution upon contact under injection conditions and under conditions in the basaltic formation.

8. The method of claim 1, wherein the first salt solution comprises a first thermogenic agent and the second salt solution comprises a second thermogenic agent, wherein the thermogenic reaction comprises reaction of the first thermogenic agent with the second thermogenic agent.

9. The method of claim 8, wherein the first thermogenic agent is selected from the group consisting of ammonium chloride, ammonium bromide, ammonium nitrate, ammonium sulfate, ammonium carbonate, ammonium nitrite, ammonium hydroxide, and combinations thereof.

10. The method of claim 8, wherein the second thermogenic agent is selected from the group consisting of sodium nitrite, potassium nitrite, sodium hypochlorite, and combinations thereof.

11. The method of claim 1, wherein the CO₂-rich fluid is prepared by dissolving a source of CO₂ in an aqueous fluid.

12. The method of claim 1, wherein enhancing the reaction between the one or more metal ions and the CO₂-rich fluid comprises increasing a rate of reaction between the CO₂-rich fluid and the one or more metal ions, whereby the treating comprises enhancing a mineralization rate in the basaltic formation.

13. The method of claim 1, wherein enhancing the reaction between the one or more metal ions and the CO₂-rich fluid with the heat comprises increasing a temperature of a mineralization mixture comprising the one or more metal ions and the CO₂-rich fluid via the heat.

14. The method of claim 1, wherein the reaction between the one or more metal ions and the CO₂-rich fluid comprises precipitating CO₂ from the CO₂-rich fluid in the form of one or more metal carbonates, thereby sequestering the precipitated CO₂ in the basaltic formation.

15. A system for treating a basaltic formation comprising a metal ion source, the system comprising:
a CO₂-rich fluid comprising a source of carbon dioxide dissolved in a first aqueous fluid;
a first salt solution comprising a first thermogenic agent dissolved in a second aqueous fluid; and
a second salt solution comprising a second thermogenic agent dissolved in a third aqueous fluid.

16. The system of claim 15, wherein the source comprises carbonic acid.

17. The system of claim 15, wherein the first thermogenic agent is selected from the group consisting of ammonium chloride, ammonium bromide, ammonium nitrate, ammonium sulfate, ammonium carbonate, ammonium nitrite, ammonium hydroxide, and combinations thereof.

18. The system of claim 15, wherein the second thermogenic agent is selected from the group consisting of sodium nitrite, potassium nitrite, sodium hypochlorite, and combinations thereof.

19. The system of claim 15, wherein the first thermogenic agent is ammonium chloride and the second thermogenic agent is sodium nitrite.
